(19) United States
(12) Patent Application Publication
(10) Pub. No.: US 2006/0167869 A1
(43) Pub. Date: Jul. 27, 2006

(54) Multi-path simultaneous Xpath evaluation over data streams

(76) Inventor: Kevin Jones, Harrogate (GB)

Correspondence Address: Welsh & Katz, Ltd.;Jon P. Christensen, 22nd Floor, 120 South Riverside Plaza, Chicago, IL, 60606, US

(21) Appl. No.: 11/341,054

(22) Filed: Jan. 27, 2006

Related U.S. Application Data
(60) Provisional application No. 60/647,632, filed on Jan. 27, 2005.

(51) Int. Cl. G06F 7/00; G06F 17/30

(52) U.S. Cl. 707/4

(57) ABSTRACT

A method and apparatus are provided for performing simultaneous XPath evaluations over an XML data stream. The method includes the steps of providing an XML data stream consisting of a sequence of information items, providing a search query consisting of a graph of search patterns, searching a sequence of information items of the XML data stream along one or more directions using the search patterns and terminating the search of each direction of the one or more directions when no further results are possible.

### FIELD OF THE INVENTION

The field of the invention relates to the searching of documents and more particularly to encoding of documents under the XML format.

### BACKGROUND OF THE INVENTION

This application is a continuation-in-part of U.S. Ser. No. 10/422,597 filed on Apr. 24, 2003 (pending).

Extensible Markup Language (XML) is a standardized text format that can be used for transmitting structured data to web applications. In this regard, XML offers significant advantages over Hypertext Markup Language (HTML) in the transmission of structured data.

In general, XML differs from HTML in at least three different ways. First, in contrast to HTML, users of XML may define additional tag and attribute names at will. Second, users of XML may nest document structures to any level of complexity. Third, optional descriptors of grammar may be added to XML to allow for the structural validation of documents. In general, XML is more powerful, is easier to implement and easier to understand.

However, XML is not backward-compatible with existing HTML documents, but documents conforming to the W3C HTML 3.2 specification can be easily converted to XML, as can documents conforming to ISO 8879 (SGML). Further, while XML allows for increased flexibility, documents created under XML do not provide a convenient mechanism for searching or retrieval of portions of the document. Where large numbers of XML documents are involved, considerable time may be consumed searching for small portions of documents.

For example, in a business environment, XML may be used to efficiently encode information from purchase orders (PO). However, where a search must later be performed that is based upon certain information elements within the PO, the entire document must be searched before the information elements may be located. Because of the importance of information processing, a need exists for a better method of searching XML documents.

### SUMMARY

A method and apparatus are provided for performing simultaneous XPath evaluations over an XML data stream. The method includes the steps of providing an XML data stream consisting of a sequence of information items, providing a search query consisting of a graph of search patterns, searching a sequence of information items of the XML data stream along one or more directions using the search patterns and terminating the search of each direction of the one or more directions when no further results are possible.

### BRIEF DESCRIPTION OF THE DRAWINGS

FIG. 1, is a block diagram of a system for processing an XML document in accordance with an illustrated embodiment of the invention; and

FIG. 2 is a block diagram of the query processor of FIG. 1.

### DETAILED DESCRIPTION OF AN ILLUSTRATED EMBODIMENT

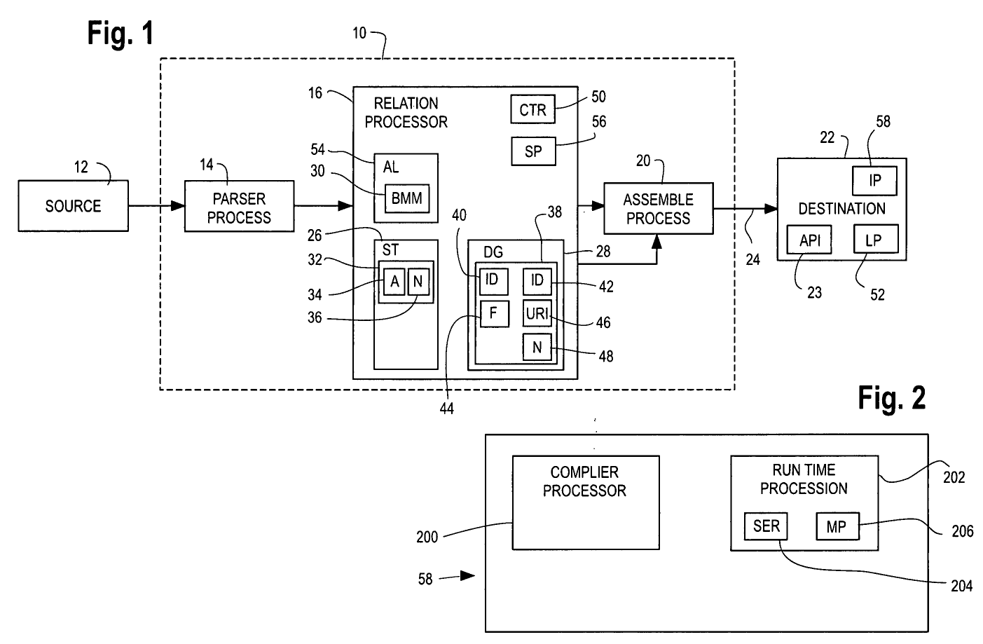

FIG. 1 depicts a system 10 for creating an Event Stream (ES) 24 from a representation of an XML document and for locating portions of that document, shown generally, under an illustrated embodiment of the invention. While in general terms, FIG. 1 shows what appears to be a source 10 and destination 22, it may be assumed that the system 10 has the same information locating capabilities as the destination 22. As such, a distinction will not be made between the source system 10 and destination system 22 because it will be assumed that the systems 10, 22 have the same overall capabilities with regard to processing the ES stream 24.

As used herein, a representation of an XML document may be a conventional XML document formatted as described by the World Wide Web Consortium (W3C) document Extensible Markup Language (XML) 1.0. The representation of the XML document may also be a Document Object Model of the XML document or a conversion of the XML document using an application programming interface (API) (e.g., using the “Simple API for XML” (SAX)).

An Event Stream may consist of an ordered sequence of information items of a conventional XML Document, plus a series of short-hand references and navigational records. Unlike a conventional XML Document, the information items in an Event Stream are encoded in a manner that can be efficiently processed using a common XML processing API (Application Programming Interface).

The ES format is most closely related to a serialization of the output of an XML parser, except as noted below. In that respect, it has a number of similarities to some of the encoding characteristics of the SAX interface. In addition to forward iteration through the data, the ES format supports reverse iteration. The ES may also use a symbol table 26 for XML names and a structural summary of the encoded document.

While the ES described below is defined as a data format, its use is supported by an application library 54 that provides additional features. The memory management for each ES stream is pluggable allowing for streams to be wholly maintained in main memory or paged or streamed as needed by an application. The library also provides a bookmark model 30 that may locate an individual event in any loaded ES stream via a single 8-byte marker.

It should be recognized that the ES format is not designed to provide compression with respect to the original document size as is common with XML encoding's. One significant advantage of ES is to enable efficient iteration over the encoded data to locate portions of the document while not imposing an excessive format construction cost. In general ES streams are generally directly comparable in size to the original document.

An overview of the ES event format will be provided first. The ES format is generated by a relationship processor 16 and assembly processor 20 that serialize post parse XML information items based upon recognition of a series of events that may each result in the insertion of one or more records into the ES 24.

The occurrence of an event may result in a series of steps being performed that creates the elements of the ES 24. It should be noted that as used herein, reference to a step also refers to the structure (i.e., the computer application or processor) that performs that step.

The format starts with the insertion of a header and continues with the introduction of variable and fixed length ‘event’ records into the ES 24. The events may be of one of two types, external or internal. An external event corresponds to an information item that should be reported to an application 23 reading a stream while internal events are used to maintain decoding data structures. All of the event records have a common encoding format that consists of the event length, the event type, the event data and the event length again. The event length does not include the size used to encode the preceding and following lengths themselves, just the event data.

The presence of the event lengths in the ES 24 allows a query iteration processor 58 at a destination 22 to iterate in either a forward or reverse direction by the provided event lengths to locate portions of the document. A symbol table and data guide function as navigational aids to the query processor 58.

At the beginning of a document, the relationship processor 16 inserts an ES header. The ES header contains a 4-byte identifier “ES” byte swapped to create 0x45524949 and a 4-byte version number stored in network byte order. The relationship processor 16 also activates a stream counter 50. The stream counter 50 may be used to determine offsets and event lengths.

Following the header, the relationship processor 16 inserts a start record. The first event record is always a start document event while the last event record is always an end document event.

Size and offset values written from the stream counter 50 into the ES 24 (e.g., into a start record) under the format are 64 bit values to allow the encoding of very large streams. These values are encoded using a 7-bits to a byte model with the most significant bit being used as a continuation marker. Values less then 128 are thus encoded as a single byte containing the value. Larger values are stored over multiple bytes with all but the last having the highest bit set. Each continuation byte contains the next most significant 7 bits of the encoded value up to the maximum of 10 bytes.

The symbol table 26 and data guide 28 will be discussed next. The symbol table and data guide (a structural summary of the document) are notionally in-memory data structures that provide metadata on the document. As used herein, the term “data guide” refers to a data guide similar to that described by R. Goldman and J. Widom in “Enabling Query Formulation and Optimization in Semistructured Databases (Proceedings of the 23^{rd} VLDB Conf., pages 436-445 (1997)). The reader should note in this regard, that the data guide of R.Goldman and J. Widom was used for databases and therefore constitutes a substantially different purpose and context than the data guide described herein.

The structures of the symbol table and data guide may be generated during the ES encoding phase and be used to substitute atoms for names, element/attribute or uri/name pairs. (As used herein, an “atom” is to a short-hand reference used in the ES 24 to refer to an element/attribute name pair or universal resource locator (uri)/name pair within the symbol table and data guide table.) In this case, a substitution processor 56 substitutes atoms for element/attribute uri/name pairs into the ES 24. At a destination 22, the structures may be used independently by ES processing applications for other purposes such as for reducing the search space of a query directed to identifying a portion of the document.

The structures of the symbol table and data guide present a difficulty during construction in that they cannot be completed until the whole document has been parsed. This means that they could not be written in their entirety until after all other ES events have been encoded. This would create a problem for applications receiving a ES stream, as decoding could not start until after the whole stream had been received and these structures had been re-created.

The solution employed by the system 10 in creation of the ES 24 is that the relationship processor 16 encodes the structures 26, 28 incrementally during the encoding of the document and inserts the encoded symbol table and data guide records into the ES stream as they are created. This means that an application receiving an ES stream can incrementally re-construct the two data structures as it processes the stream. Alternatively where streaming functionality is not required, e.g. in-process, then the symbol table and data guide created during document encoding can be passed directly to the recipient if appropriate thereby avoiding the overhead of reconstruction.

The internal events record encoded by the system 10 will be discussed next. The internal events encoded in a stream are used to describe the symbol table, data guide & maintain correct error handling semantics.

If ES data is being streamed between processes, then the question arises of how to handle an error occurring in the encoding (e.g., a parser error due to an invalid document). Given that the ES 24 only defines a data format there is no obvious way to directly communicate errors to the stream recipient. Instead, errors reported during encoding are encoded as events (error records) under the ES format. As the recipient processes the stream any error events will be discovered and can be reported to the recipient just as though the recipient in directly parsing the input document had found the error. The format for error events consists of the ES_ERROR event code followed by an error message in UTF-8 string format.

As mentioned earlier, XML names are replaced by atom values obtained from the symbol table 26. If a new name 36 is discovered during encoding it is assigned a unique value 34 within a symbol table name pair entry 32 of the symbol table 26 and an event (name pair record) is added to the data stream to record the association between atom value and name. The event consists of the ES_SYMBOL event code followed by the encoded atom value, the encoded size of the symbol and the symbol in UTF-8 string format.

To aid receivers that have difficulty handling UTF-8, a distinction is made during encoding between symbols containing just ASCII characters and those that contain characters outside the ASCII range. ASCII only symbols are recorded with the event ES_SYMBOL_ASCII that has substantially the same structure as a ES_SYMBOL event. Only a limited number of bytes are checked to determine if a string is ASCII meaning that large strings will be marked ES_SYMBOL (i.e., not ASCII) even if they contain only ASCII characters.

The final internal event used by the ES format is the ES_DG event. This encodes an addition to the data guide and into the ES 24 in the same manner that ES_SYMBOL adds to the symbol table and ES 24. The data guide is structured as a tree of entries, where each entry represents the occurrence of an element (information item) or attribute of an element and is recorded as a child of the element that is associated with the parent data guide entry. Thus every element or attribute of the encoded document has an associated entry record 38 in the data guide 28 and elements/attributes that have the same ancestor structure share the same data guide entry 38. To aid quick lookup (e.g., by a locating processor 52 at a destination 22) all data guide entries are assigned a unique identifier 40 that can be used to index the entries in a table. The format of the ES_DG event is entry id 40, the id of the parent entry 42, a flag 44 indicating if this is a element or attribute entry followed by the symbol table identifiers for the uri 46 and name 48 of the element or attribute.

ES uses data guide entries (records) to encode element & attribute details. In this respect, the data guide acts as a lookup table for uri/name pairs (e.g., given that a data guide entry identifier 40 for an element is known, it is a trivial matter to resolve the uri 46 and name symbols 48 used on that element).

The start and end events of the XML stream will be discussed next. The start and end document event records are simple markers used to determine the start and end of the data stream being traversed. Each event carries no data items and so is encoded directly as either ES_START_DOCUMENT or ES_END_DOCUMENT.

The start and end element events (records) will be discussed next. The start of an element within the stream 24 is marked with an event record containing the ES_START_ELEMENT marker, the Data guide entry identifier for the element type, a symbol table identifier for the prefix (or “ ” if no prefix was used) and the encoded offset to the parent entry record in the stream.

Immediately following the start element record will be any namespace records declared on that element followed by any attribute records of that element. This ordering has been chosen so that it matches the ‘document order’ define by XPath, i.e. sorting elements with respect to their offset in the stream also sorts them into XPath document order.

After the element name space records and attribute records, any child content records follow such as text node records or child element records. At the end of the child events is an end element event record, marked with ES_END_ELEMENT. The end element contains the data guide entry index record for the element being closed.

The parent entry offset record may be included within each child event to allow for quick navigation to ancestors, say during XSLT pattern matching or resolution of in-scope namespaces. In practice, many applications 23 may choose to cache ancestor event information in memory as this is relatively cheap to perform where element nesting is not excessive.

Namespaces will be discussed next. Each declared namespace is indicated with an ES_NAMESPACE mark record following the element it was declared on. The namespace event contains the symbol table index for the namespace name and uri. The XML namespace is not explicitly declared as an event but is implicitly declared by both encoder and decoder for the ES 24 (e.g., The prefix ‘xml’ can be resolved on any ES stream).

It is also worth noting that the binding between an element or attribute and the namespaces declaration that provides a valid prefix for it is not preserved. The element/attribute only contains that resolved uri and prefix, although the namespace declaration that was in-scope to provide the uri can be located by searching the event ancestor events.

Attributes will be discussed next. Attribute declaration records use the ES_ATTRIBUTE mark. Like element records they contain the data guide entry identifier for the element type, a symbol table identifier for the prefix (or “ ” if no prefix was used). In addition, they also contain the value of the attribute as a UTF-8 encoded string. The encoded length of the string precedes the value, as it is not NULL terminated.

Text or character data will be discussed next. Text events are split in a similar way to symbol table entries into ASCII (ES_TEXT_ASCII) only and non-ASCII (ES_TEXT) versions to aid the receiver. The event data for both these event records contains the encoded length of the string followed by the string itself. There is no separate representation for cdata sections so these will also appear as text events in the encoding.

Comments will be discussed next. Comments are encoded in an identical manner to text event records but using the ES_COMMENT marker.

Processing instructions will be discussed next. Each processing instruction is encoded as an instruction record with the ES_PI marker followed by a symbol table identifier for the target of the processing instruction. The data of the instruction is written as an encoded string length followed by the data string itself in UTF-8 format.

Buffering of the ES stream will be discussed next. If an ES data stream is transmitted between two applications as a stream, it can be difficult to manage the decoding of a stream where individual events may be arbitrarily split across buffers. This difficulty can lead to less efficient decoding strategies than would be possible if there is some agreement over buffer sizing between the applications. In the ES 24 there is an internal alignment multiple that is used to place events such that the receiver does not have to perform buffer boundary checks for most data access of the stream. This alignment may be provided on 4k byte boundaries. If an event that has a fixed maximum size would cross a boundary, then the stream is padded to the boundary and the event is written in complete form after the boundary.

There are a number of event records for which there is no fixed maximum size. In these cases the events may be defined such that the variable component always comes at the end. Thus for these events if the part that has a fixed maximum size cannot be written before a boundary re-occurs, then the stream is padded and the event is written after the boundary. The variable parts of these events can be written at any point in the stream and can span any boundary encountered in so doing.

This rather complex set of guarantees can be used by a receiver that uses a multiple of the boundary size to make key assumptions about location of events it is reading. Namely, the next/last event will either have all its critical data in this buffer or the next/last. In practice, this means that buffer boundary checking is performed only once per-event not once-per data item read while only restricting the encoder and receiver to use of a multiple of the 4K byte boundary size.

One extra consideration is that to handle small documents efficiently, the last buffer (or only buffer) can be a multiple of a 1K boundary. Hence the minimum encoded stream size is 1K.

The creation of the ES 24 from the XML parser events will be discussed next. The following Table I summarizes the processing steps to create the navigation records inserted into an ES data stream 24 by the assembly processor 20. On the left hand side is listed the incoming events normally provided by a XML parser. On the right hand side is the action taken by the processor 16 in response to each event to produce the ES 24.

A side effect of the actions is the production of a symbol table 26 and data guide 28 that may or may not be reused for other types of processing.

TABLE I

| | |
|---|---|
| Start of Document | Write on output stream, |
| | Format identifier |
| | Version identifier |
| | Start document record |
| | Add symbols for, |
| | Empty string |
| | XML namespace URI |
| End of document | Write on output stream, |
| | End document record |
| Start namespace | Add symbols for prefix and name |
| | Cache namespace details |
| End namespace | No action |
| Start element | Add symbol for name |
| | Locate symbol for namespace |
| | Add data guide entry for element |
| | Calculate offset from current element to parent |
| | Write on output stream start element record |
| | For each cached namespace |
| | Write on output stream a namespace record |
| | For each attribute of the element |
| | Add symbol for attribute name |
| | Locate symbol for attribute namespace |
| | Add data guide entry for attribute |
| | Write on output stream an attribute record |
| End element | Write on output stream end element record |
| Character data | If last record was character data and can be extended |
| | Extend record with new data |
| | Else |
| | Write character data event |
| Comment | Write on output stream comment record |
| Processing | Add symbol for target of processing instruction |
| instruction | Write on output stream processing instruction record |
| CDATA Section | As per character data |

The query processor 58 of the system 10 may be used to for performing simultaneous XPath expression evaluations by searching over the XML data stream using a unique hybrid process. Expression evaluation in this case means locating something within the stream that matches a search query.

In the past, most implementations of the W3C recommendation for finding things within XPath, have been based on the evaluation of single expressions at a time. Multiple simultaneous evaluations of expressions are an important performance enhancement in the areas of XML document classification and publish/subscribe systems. The hybrid process is significant in the context of simultaneous expression evaluation in that it is the first to allow the implementation of the complete XPath recommendation while not sacrificing evaluation speed.

The hybrid process within the query processor 58 works by operation of a search engine 204 iterating over a data stream during processing. The iteration model is somewhat unusual in that it offers the ability for both forward and reverse navigation. The data stream contains an encoding of the type of events normally generated by an XML parser, such as a “start element” and a “text” event. As is typical, such a stream is encoded in document order, meaning the events are recoded as you could find them by reading the XML document from the top to the bottom. In addition to reverse navigation, the stream also supports ancestor navigation, i.e. the ability to locate an ancestor of an element directly without performing a reverse scan. A fuller description of format upon which the hybrid process operates, known as ES, has been provided above.

The traditional approach to simultaneous XPath evaluation has been to compile the XPath expressions into automated processes (automata) of some form. The automata accept events from a parser and perform some action as a result. The goal is to make the completion of each event a constant time operation thus ensuring that processing time for any given document is constant with respect to the number of expressions being evaluated.

One of the more successful implementations of the automata model was described in the publication “Processing XML Streams with Deterministic Automata” by Dan Suciu et al, University of Washington, 2002. This Deterministic Finite “State” Automaton (DFA) can be used to implement a relatively fast simultaneous XPath evaluation implementation with acceptable memory usage. However, the DFA suffers from limited XPath axis support and limited predicate handling functionality. The hybrid process is somewhat related to the DFA but is significantly different in enough ways to form a class of process on its own.

Conceptually the main advance in the hybrid process is the use of a multiple bi-directional automata (search threads) to describe the search space for a set of expressions. These automata are linked as shown in a graph structure (described below) such that the starting state of any particular automata in any particular direction is triggered from an accepting state of some controlling automata of the search engine 204.

In earlier models that push event stream input into a particular automata, all processing must be performed in strict document order. As the hybrid process allows for both forward and reverse processing it must use a pull-processing model where the automata searches the data stream from some position in forward, reverse or both directions. The term ‘automata’ has traditionally only been used in computer science to only describe push processing models, it will be used herein to describe the hybrid pull processing model (as the swap from push to pull processing is a minor detail to enable bi-directional searching).

It has been previously shown that XPath expressions involving reverse axis searches can be transformed into searches with only forward searches. Forward only searches may however be significantly more expensive to compute and cannot be used if the expression is to be evaluated from some unknown (at compile time) position in the document, as is commonly the case with the XSLT language.

In one illustrated embodiment, the hybrid query code is restricted to using just the following, preceding and parent/ancestor axis. In another illustrated embodiment, it is envisaged that allowance may be made for supporting subsets or superset of these axis, (e.g., forward only searching). In the hybrid process, the XPath axis are designed as layers over this primitive axis, so preceding-sibling are implemented as part of a preceding-search. It should be clear that by searching either forward, backward or in both directions from some point in an ES stream it is possible to locate any other data item. This type of search may be less efficient in comparison to a fully indexed data searching but it is practical and the goal of hybrid processing is to minimise the costs of doing so.

The XPath recommendation defines a single expression language but from the point of view of a programmer it is often better to view it as two languages. One is concerned with data queries over a set of documents while the other the evaluation of expression based on those results. In this two-language view both parts are mutually dependant on each other, which complicates the interaction considerably but does give the illusion of XPath as a fully integrated language. We are primarily interested in the data query component of XPath so the implementation details of expression evaluation will not be discussed in any great detail.

In the implementation of the hybrid process, there are two software components, a compiler 200 component and a runtime component 202 (FIG. 2). The compiler accepts sets of XPath expressions and produces virtual machine code (for a description of virtual machines and virtual machine code, the reader is referred to parent application Ser. No. 10/422,597, incorporated herein by reference). The runtime component implements the virtual machine and support code that can execute the code. To avoid burdening this description with excessive detail, only the model used by the compiler to communicate to the runtime component how to perform a query over a document will be described. In the implementation of FIGS. 1 and 2 this may be considered to be a binary blob of data associated with a single virtual machine instruction but it will be represented as a query model to aid understanding. The sections after the description of the query model will cover some of the more complex issues of mapping XPath expressions onto that model.

Each query in the hybrid process is described by a graph of nodes with multiple entry points. The entry points correspond to the possible starting locations for the expressions being evaluated. Often only a single entry point for the user-defined ‘context’ position is present, but many other types of start point are also possible.

The nodes in the query graph (node path followed by the hybrid process) are similar to states in automata with outgoing edges to other states. Each query node defines one or more search paths to be followed to discover results relevant to the XPath expressions being evaluated. On the discovery of a relevant data item during such a search the location of the matching data item may be stored for later use and/or the query may progress to another query node for further searching to be performed. The query graph thus defines a process to be executed by some implementation that (if followed correctly) results in the locations of some interesting data item being saved.

To give a small example, the query model (search pattern) for the expressions “a/b” and “a/c” would contains two nodes. In this example, the graph of search patterns may be represented as follows.

[image]

An interpretation of this structure would be,

At Node 1 search the child data items of the context item, for each item found
If the item matches the pattern “a” (as detected by matching processor 206) continue at Node 2 (with the matching node as the new context data item)

At Node 2 search the child data items of the context item, for each item found
If the item matches the pattern “a” save the location of this item a “1” & continue with next item
If the item matches the pattern “b” save the location of this item a “2” & continue with next item.

Each query node thus has some internal structure describing how the search should be performed. The structure of the query contains a list of one or more axis searches with each axis search containing a list of one or patterns that could be checked against (matched). It is important to recognize that the search patterns are ordered and terminate searches on that axis, i.e. once a match is located no further patterns are tested for that data item. In this example this distinction was not important, as there is no node that could match both the patterns “a” and “b”. However if we change the second expression to be “a/*” then the generated query nodes of the graph of search patterns would appear as follows.

[image]

[image]

Here we interpret a match on pattern “b” as meaning save the result at both location 1 & 2 and continue with the next data item. So if the data item does match “b” there is no need to continue testing to check if it matches following patterns.

The Hybrid process exhibits performance somewhat similar to that of DFA methods since the hybrid method allows for the equivalent of constant time searching for each node and therefore linear searching of the whole document. This is assuming that patterns can be matched in constant time in the same way that DFA outgoing edges can be selected in constant time. In reality neither of these is true but it is possible to achieve a close approximation via the choice of appropriate data structures for storing pattern matches.

In this case as the children of the “a” node are examined, a single pattern can be selected to follow to complete the search for each child. If there were two possible matches then both would have to be evaluated which results in a multiplication of the time need to evaluate the query. This is clearly a fairly trivial example. So to illustrate these points better a more complex case follows, along with its query nodes.

For the expressions

[image]

The query nodes of the graph of search patterns would be arranged as

[image]

The process of creating a query is analogous to that of performing a Non-Deterministic Finite “State” Automaton (NFA) to DFA conversion, i.e. it removes non-deterministic behavior, which results in larger but fundamentally quicker runtime structures.

The problem of size explosion often associated when converting from an NFA to DFA could also be a problem with this form of query. In the case of the hybrid process, various techniques are used to limit the growth of the query structure. In the example above, it should be clear why the structure is a graph rather than a tree (i.e., there are references from some nodes to others). The purpose of supporting this type of linkage is to limit the tree size growth. In addition to this you can also see the use of descendant as an axis type where it is possible, i.e. where a child test is not needed. Using the most compact search model not only helps keep the size of the query structure down but also helps improve runtime performance.

Another technique used to limit the size of the query structure is to allow for non-deterministic behavior at the outer nodes. At a pre-defined nesting depth the hybrid compiler stops expanding the residual expressions and codes them directly into the tree. During evaluation this limit is known and once reached pattern searching continues beyond the first match. In practice this means the performance profile at this depth changes from constant time, to time dependent upon the number of pattern matches on a node. This is clearly not optimal but it halts the rapid expansion of structure tree growth in the worst case.

Each query node contains patterns to be evaluated along one or more directions. The directions share some common names and meanings with the XPath axis model. There are however some differences and no inherent limitations on what a direction may be. Each direction can abstractly be thought of as a type of index (i.e. given a context node, a direction name returns all matching entries). In this model a direction may be “all elements with the same id attribute as the context node” as easily as “being all children of the context node”. The patterns used for a direction are thus entirely dependant upon the type of direction being examined. For example, when searching text nodes there may be no patterns (as in the case of XPath) or the patterns may be regular expressions.

When using the hybrid model over ES we know that three directions are built in, these in XPath terminology are the preceding, following and ancestor axis. In addition to these hybrid supports the use of self, attribute, child, descendant, following-sibling, following-parent, preceding-sibling and preceding-parent axis.

The attribute direction is used to implement the attribute axis in XPath but it does so in a slightly unusual way. It is common in XPath to write paths that contain attribute tests in predicates. These test are commonly attribute value equality tests. As an optimisation, the hybrid attribute direction directly supports patterns of this type by allowing optional values to be provided for equality testing. It also allows for direct evaluation of the predicates by defining the attribute direction as a search for the first attribute that matches the patterns. This means that query nodes using attributes can link to other query nodes that continue searching for other attributes or on other directions. For example, given the path “/a[@id=‘foo’]/b” it can be directly represented as a query structure as,

[image]

[image]

The following-parent and preceding-parent are helper directions that are used to aid the decomposition of the following and preceding axis. In constructing a query structure, the Hybrid compiler takes into account the overlap between XPath axes to produce the compact queries. It does this by expanding the original axis into a form that makes merging between paths easier. For example, given a child and descendant search, the descendant search can be re-expressed in the graph of search patterns as a child search followed by a descendant search, this allows the child searches to be easily combined together into one query node.

When dealing with following and preceding relationships the compiler can generate a following or preceding search “meaning identifying search nodes” before or after the subject of the context data item. For example, when dealing with a following-sibling and preceding-sibling, the compiler 200 may generate a following-parent or preceding parent search pattern as a bridge among siblings.

The patterns used on each direction are currently identical with the noted exception above for attributes and also for namespaces. For other axis patterns, search queries can be specified for text and comment nodes without arguments, for processing-instructions with/without a target string and for elements with uri/name combination including wildcards. The namespace direction supports searching by prefix or wildcard.

The hybrid query structure generated by the compiler 200 does not prescribe how the document should be searched. The most efficient searching model is largely a function of the organisation of the data being searched. In the case of ES that means data items are placed in document order hence depth first searching is the natural choice to maintain cache consistency and limit buffer changes. The query node directions are sorted into an order that favours closer and forward searches over reverse searches. There is no requirement that searching takes place in this way but it is the natural choice given that layout of the ES data items.

The evaluation of a query model is fairly straight forward given an understanding of the supported directions and their patterns models. In practice, data item location caching is used to speed the evaluation. The caching model is relatively simple although it may be expanded as the need arises.

At each query node, a pair of hint values is established, one for the next sibling and one for the next sibling of the parent of the context. As used herein, the term “hint” means a structural relationship that is identified during a current search that is not relevant to the current search, but may be useful in another search within the graph of search patterns. These hints may be left null or set by the actions of evaluating some direction of the query node. In the most common case of child searching and at the completion of the search, the end of the scope of the context node has been located. Thus the location of the next sibling is known and can be recorded as a side effect in the hint. When searching resumes at the previous parent query node, this hint may be used to locate the next sibling to be searched without the need for scanning through the event data to locate it. This form of caching obviously relies on the depth first search process being used to evaluate the query structure but as was pointed out earlier this is the most efficient given the data items are encoded in document order as with ES.

The detail of how the query model is generated is beyond the scope of this description but to complete the picture, a simplified overview of the process has been given herein. The goal during generation is to produce the most compact correct query possible as smaller queries can generally be evaluated quicker.

The process is recursive and starts with a notional context node in the query with a context data item and a set of paths. The compiler operates first by determining if a search performed in one of a number of directions along any of the paths could possibly result in a match between the query and the data items found. If it is determined that that match would be possible, a new query node is created within the graph of search patterns and the subset of paths that could match a direction are located. From the possible matching paths a set of “interesting” data items are produced. For each item and path, the effect of finding that item during a search is calculated, the pattern for the data item is added to the existing node and the process is recursively applied to that new node. The selection of which direction to search and what constitutes an “interesting” data item for that direction are tightly controlled to avoid unnecessary growth in any direction.

The hybrid process supports a subset of the XPath path expressions. Any direct support for the evaluation of predicates (excluding the special handling for attribute equality tests) is omitted as described earlier. As predicates can contain any XPath expression, it is not feasible to evaluate them in the general case as part of a query search. In the process of the Hybrid model, attributes are treated in a special manner because of their common use. As the need arises more types of predicate may be handled inline in this manner.

For the general case, the results of the query are post-processed to filter the query results to correctly reflect the predicates that the expression may have contained. To achieve this, the results of a query evaluation must store context information around the parts of an expression that have predicates in them. For example, in “a[2]/b” it is not sufficient to just know all the result of evaluating “a/b” but instead it is necessary to know which “b” elements were found for each “a” element. This is achieved in the hybrid process by storing both a context item and result item. In this example case each “b” is stored relative to some “a” value. When evaluating the results of this expression just the “b” results corresponding to the second “a” result can be retrieved.

To simplify the process of result context storing all results in a query structure are stored relative to some context node. This may be a local context as in the example above or relative to context data item that was used to start the search (normally the document root node). For simple path expressions that do not involve predicates there is no need to perform post-processing operations but for many types of expressions the results of the hybrid evaluation are made available to secondary processing logic to produce a final result.

In some use cases it is desirable not to wait for completion of a query to report results. The process of reporting quickly may be referred to as early matching. Consider for example the expression, “(/a/b)[1]”. Clearly only one data item can be matched by this expression. Rather than wait for the complete evaluation of “/a/b” before reporting that a data item has been found, the expression can be early matched to indicate a result has been found. Support for early matching is almost entirely implemented by the compiler but there is a small amount of support for it in the hybrid runtime. In short, a result can be tagged as being of interest to a reporting group. The group contains a list of result identifiers and a callback identifier. When a data item is found for any of the results in the group the whole group is checked to see if all have results. If all members of the results now have results, the callback is invoked. It is expected that this callback will attempt an early evaluation of the expression and report its results in the normal way. The expression compiler is responsible for selecting the expressions that might be suitable for early evaluation and generating the code that will be invoked as a result of the callback.

A specific embodiment of method and apparatus for searching an XML document has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of performing simultaneous XPath evaluations over an XML data stream comprising:
providing an XML data stream consisting of a sequence of information items;
providing a search query consisting of a graph of search patterns;
searching a sequence of information items of the XML data stream along one or more directions using the search patterns; and
terminating the search of each direction of the one or more directions when no further results are possible.

2. The method of performing simultaneous XPath evaluations as in claim 1 wherein the step of searching the sequence further comprises determining a context data item.

3. The method of performing simultaneous XPath evaluations as in claim 1 further comprising completing a first search direction of the graph of search patterns before starting a second search pattern of the graph of search patterns in the particular direction.

4. The method of performing simultaneous XPath evaluations as in claim 3 further comprising determining a direction of the one or more directions based upon a predicate attribute.

5. The method of performing simultaneous XPath evaluations as in claim 1 further comprising storing a location of a match from a first search pattern for use in conjunction with a second search pattern from another location of the graph of search patterns.

6. The method of performing simultaneous XPath evaluations as in claim 1 wherein the one or more directions further comprises a preceding search.

7. The method of performing simultaneous XPath evaluations as in claim 1 wherein the one or more directions further comprises a following search.

8. The method of performing simultaneous XPath evaluations as in claim 1 wherein the one or more directions further comprises an ancestor search.

9. The method of performing simultaneous XPath evaluations as in claim 1 wherein the query further comprises a search of XPath axis types.

10. The method of performing simultaneous XPath evaluations as in claim 1 further comprises linking a first attribute of the first search pattern of the graph search patterns to a second attribute of a second search pattern of the graph of search patterns.

11. The method of performing simultaneous XPath evaluations as in claim 1 wherein the search query further comprises a child and descendent search.

12. The method of performing simultaneous XPath evaluations as in claim 11 further comprising forming a child search pattern followed by a descendent search pattern within the graph of search patterns.

13. The method of performing simultaneous XPath evaluations as in claim 11 further comprising generating a following-parent or preceding parent search pattern as a bridge among siblings

14. An apparatus for performing simultaneous XPath evaluations over an XML data stream comprising:
an XML data stream consisting of a sequence of information items;
means for providing a search query consisting of a graph of search patterns;
means for searching a sequence of information items of the XML data stream along one or more directions using the search patterns; and
means for terminating the search of each direction of the one or more directions when no further results are possible.

15. The apparatus for performing simultaneous XPath evaluations as in claim 14 wherein the means for searching the sequence further comprises means for determining a context data item.

16. The apparatus for performing simultaneous XPath evaluations as in claim 14 further comprising means for completing a first search direction of the graph of search patterns before starting a second search pattern of the graph of search patterns in the particular direction.

17. The apparatus for performing simultaneous XPath evaluations as in claim 15 further comprising means for determining a direction of the one or more directions based upon a predicate attribute.

18. The apparatus for performing simultaneous XPath evaluations as in claim 14 further comprising means for storing a location of a match from a first search pattern for use in conjunction with a second search pattern from another location of the graph of search patterns.

19. The apparatus for performing simultaneous XPath evaluations as in claim 14 wherein the one or more directions further comprises a preceding search.

20. The apparatus for performing simultaneous XPath evaluations as in claim 14 wherein the one or more directions further comprises a following search.

21. The apparatus for performing simultaneous XPath evaluations as in claim 14 wherein the one or more directions further comprises an ancestor search.

22. The apparatus for performing simultaneous XPath evaluations as in claim 14 wherein the query further comprises a search of XPath axis types.

23. The apparatus for performing simultaneous XPath evaluations as in claim 14 further comprises means for linking a first attribute of the first search pattern of the graph search patterns to a second attribute of a second search pattern of the graph of search patterns.

24. The apparatus for performing simultaneous XPath evaluations as in claim 14 wherein the search query further comprises a child and descendent search.

25. The apparatus for performing simultaneous XPath evaluations as in claim 24 further comprising means for forming a child search pattern followed by a descendent search pattern within the graph of search patterns.

26. The apparatus for performing simultaneous XPath evaluations as in claim 24 further comprising means for generating a following-parent or preceding parent search pattern as a bridge among siblings

27. A method of performing simultaneous XPath evaluations over an XML data stream comprising:
providing an XML data stream consisting of a sequence of information items;
providing a search query;
searching a sequence of information items of the XML data stream along one or more directions using the search patterns; and
terminating the search of each direction when no further results are possible.

28. The method of performing simultaneous XPath evaluations as in claim 27 wherein the step of providing the search query further comprises generating a graph of search patterns

29. The method of performing simultaneous XPath evaluations as in claim 27 wherein the step of searching the sequence further comprises determining a context data item.

30. The method of performing simultaneous XPath evaluations as in claim 27 further comprising completing a first search direction of the graph of search patterns before starting a second search pattern of the graph of search patterns in the particular direction.

31. The method of performing simultaneous XPath evaluations as in claim 30 further comprising determining a direction of the one or more directions based upon a predicate attribute.

32. The method of performing simultaneous XPath evaluations as in claim 27 further comprising storing a location of a match from a first search pattern for use in conjunction with a second search pattern from another location of the graph of search patterns.

33. The method of performing simultaneous XPath evaluations as in claim 27 wherein the one or more directions further comprises a preceding search.

34. The method of performing simultaneous XPath evaluations as in claim 27 wherein the one or more directions further comprises a following search.

35. The method of performing simultaneous XPath evaluations as in claim 27 wherein the one or more directions further comprises an ancestor search.

36. The method of performing simultaneous XPath evaluations as in claim 27 wherein the query further comprises a search of XPath axis types.

37. The method of performing simultaneous XPath evaluations as in claim 30 further comprises linking a first attribute of the first search pattern of the graph search patterns to a second attribute of a second search pattern of the graph of search patterns.

38. The method of performing simultaneous XPath evaluations as in claim 27 wherein the search query further comprises a child and descendent search.

39. The method of performing simultaneous XPath evaluations as in claim 38 further comprising forming a child search pattern followed by a descendent search pattern within the graph of search patterns.

40. The method of performing simultaneous XPath evaluations as in claim 38 further comprising generating a following-parent or preceding parent search pattern as a bridge among siblings.

41. A method of performing simultaneous Xpath evaluations over an XML data stream comprising:
providing a search query with a plurality of search patterns and a plurality of search axis;
simultaneously searching the XML data stream along the plurality of search axis using the plurality of search patterns; and
terminating the search along each search axis of the plurality of search axis when a match is found between at least some of the plurality of search patterns and XML data stream along the search axis.

42. The method of performing simultaneous Xpath evaluations over an XML data stream as in claim 1 wherein the plurality of search patterns further comprise a graph of search patterns.

43. An apparatus for performing simultaneous Xpath evaluations over an XML data stream comprising:
a search query with a plurality of search patterns and a plurality of search axis;
a search engine that simultaneously searches the XML data stream along the plurality of search axis using the plurality of search patterns; and
a matching processor that terminates the search along each search axis of the plurality of search axis when a match is found between at least some of the plurality of search patterns and XML data stream along the search axis.
